(19) United States
(12) Patent Application Publication
(10) Pub. No.: US 2016/0135483 A1
(43) Pub. Date: May 19, 2016

(54) Aquaculture feed formed from fermented soybean meal and earthworm meal, including the fermentation preparation method for the mixture ingredient

(71) Applicant: National Pingtung University of Science and Technology, Neipu (TW)

(72) Inventors: Chun-Hung Liu, Neipu (TW); Chiu-Hsia Chiu, Neipu (TW); Ya-Li Shiu, Neipu (TW); Wen-Teng Cheng, Neipu (TW); Shieh-Tsung Chiu, Neipu (TW)

(73) Assignee: National Pingtung University of Science and Technology

(21) Appl. No.: 14/559,877

(22) Filed: Dec. 3, 2014

(30) Foreign Application Priority Data
Nov. 18, 2014 (TW) 103139851

(51) Int. Cl. A23K 1/00; A23K 1/16; A23K 1/18; A23K 1/14; A23K 1/10

(52) U.S. Cl. CPC A23K 1/007; A23K 1/14; A23K 1/10; A23K 1/188; A23K 1/1603

(57) ABSTRACT

A method for producing a fermented aquaculture feed includes forming a powder mixture of soybean meal and earthworm meal, adding water to the powder mixture to form a first feed mixture, adding a culture of Bacillus subtilis to the first feed mixture to form a second feed mixture, and incubating the second feed mixture at a temperature of between about 20° C. and about 50° C. for a first time period to obtain a fermented feed mixture. The invention further provides a fermented feed mixture obtained from adding a culture of Bacillus subtilis to a feed mixture and incubating the feed mixture at a temperature of between about 20° C. and about 50° C. The feed mixture is obtained from adding water to a powder mixture of soybean meal and earthworm meal. The weight of the soybean meal within the power mixture may be larger than the weight of the earthworm meal.

### BACKGROUND OF THE INVENTION

1. Field of the Invention

Embodiments of the invention is related to a method of preparing a feed mixture to be used as animal feeds, such as aquaculture feeds. An aquaculture feed mixture can be prepared to feed aquaculture animals, for example, to be used as a shrimp feed. The aquaculture feed mixture can be fermented by bacteria, for example, Bacillus subtilis.

2. Description of the Related Art

White shrimp (Litopenaeus vannamei) is the primary aquaculture shrimp species raised popularly among commercial aquaculture operators in Taiwan due to its rapid growth and strong environmental adaptability. The main source of proteins within conventional aquaculture feeds come from feeding white shrimps with fish meal, which is a commercial product made from the bones and offal of processed fish. Fish meal is generally a brown powder or cake obtained by drying the fish or fish trimmings, often after cooking, and then grinding it. If it is a fatty fish it is also pressed to extract most of the fish oil. Fishmeal is a nutrient-rich and high-protein supplement feed ingredient that stores well, and is used primarily in diets for domestic animals and aquaculture animals.

However, fish meal is expensive and there is a global shortage of fish meal because of marine pollution, global climate change, and ecological damage in recent years, causing the costs of aquaculture feeds to be continuously very high. Thus, soybean meal have been used to substitute a portion of an aquaculture fish meal feed because soybean meal is cheaper in price, thereby reducing the costs in feeds in raising aquaculture shrimps.

Soybean meal used as a powder in aquaculture feeds for feeding white shrimps has the advantages of having high protein content, low costs, and stable supply. However, soybean meal has not been commonly used as aquaculture feeds, because soybean contains many anti-nutritional factors, is difficult to digest, has poor palatability and also contains unbalanced amino acid make-up for shrimps. Therefore, there is a need to improve the use of soybean meal as aquaculture feeds.

Furthermore, plant proteins within soybeans do not contain methionine, which is an essential amino acid for animal growth. Even using crystalline forms of essential amino acids in aquaculture animal feeds does not result in any significant improvement.

On the other hand, earthworm meal made from processing earthworms has been used to substitute a portion of fish meal used in an aquaculture feed mixture. However, the substitution level cannot be too high because earthworm meal contains hemagglutinin, which emits a foul odor and decreases the growth performance of aquaculture animal species.

Therefore, there is still a need for a method of preparing an improved aquaculture feed mixture to feed aquaculture animals.

### SUMMARY OF THE INVENTION

Embodiments of the invention include a method for preparing and generating an aquaculture feed mixture suitable for feeding aquaculture animals. In one embodiment, the method includes forming a powder mixture of soybean meal and earthworm meal, adding water to the powder mixture to form a first feed mixture, adding a culture of Bacillus subtilis to the first feed mixture to form a second feed mixture, and incubating the second feed mixture at a temperature of between about 20° C. and about 50° C. for a first time period to obtain a fermented feed mixture. In one example, the first time period can from about 12 hour to about 72 hours. In another example, the fermentation temperature for incubating the second feed mixture can be at an optimal growth temperature for the bacteria used, e.g., for Bacillus subtilis the optimal growth temperature is between about 37° C. and about 40° C. In one aspect, the culture of Bacillus subtilis has a concentration of between about 1×10⁶ cfu/ml and about 1×10⁸ cfu/ml. In another aspect, a weight ratio of the weight of the culture of Bacillus subtilis versus the weight of the first feed mixture is ranged from 1:15 to 1:12.

In one embodiment, a weight ratio of water versus the powder mixture within the first feed mixture is between about 20% and about 50%, such that fermentation of the first feed mixture by bacteria, such as Bacillus subtilis or other suitable bacteria suitable for fermentation is desired. For example, the weight ratio of water versus the powder mixture within the first feed mixture can be about 30%. In another aspect, the method further includes heating the first feed mixture at a temperature of about 100° C. or higher to sterilize the first feed mixture prior to adding the culture of Bacillus subtilis.

In still another aspect, the method further includes heating the fermented feed mixture at a temperature of about 100° C. or higher for a second time period to sterilize the fermented feed mixture. As an example, the second time period is from about 10 minutes to about 40 minutes. As another example, the fermented feed mixture can be heated to a temperature of 121° C. for 20 minutes. In yet another aspect, the method further includes drying the fermented feed mixture to a water content of about 10% or less by weight and make it ready to be used as a portion of an aquaculture feed.

In yet another embodiment, the invention provide an aquaculture feed having a fermented feed mixture made by the method provided herein. In one aspect, the aquaculture feed may include a fermented feed mixture at a concentration of between about 60% and about 100% by weight of the total weight of the aquaculture feed.

In another embodiment, an aquaculture feed mixture is provided and includes a powder mixture of soybean meal and earthworm meal, where the weight of the soybean meal within the power mixture is larger than the weight of the earthworm meal. In still another embodiment, a fermented aquaculture feed mixture is obtained by adding a culture of Bacillus subtilis to a first feed mixture to form a second feed mixture and incubating the second feed mixture at a temperature of between about 20° C. and about 50° C. for a first time period, wherein the first feed mixture is obtained from adding water to a powder mixture of soybean meal and earthworm meal. In one aspect, the weight of the soybean meal within the power mixture is larger than the weight of the earthworm meal.

### BRIEF DESCRIPTION OF THE DRAWINGS

FIG. 1 is a block diagram for a method 100 of producing an aquaculture feed mixture.

FIG. 2 is a line graph that illustrates how water content (weight %) of the first feed mixtures affects Bacillus subtilis E20 proliferation during the fermentation of second feed mixtures.

FIG. 3 is a line graph that illustrates how water content (weight %) of the first feed mixtures affects protein content of fermented feed mixtures.

FIG. 4 is a line graph that illustrates how water content (weight %) of the first feed mixtures affects lipid content of fermented feed mixtures.

FIG. 5 is a histogram that shows the mortality of white shrimp being fed with different experimental feed (FM, FSFEM60, FSFEM80, and FSFEM100 feed) 7 days after being infected by Vibrio alginolyticus.

### DETAILED DESCRIPTION

Embodiments of this invention provide a fermented aquaculture feed mixture and a method of preparing the fermented aquaculture feed mixture from a powder mixture of soybean meal and earthworm meal. The method of the invention is used to produce a novel fermented aquaculture feed mixture and solve the methionine deficit problem in prior fermented aquaculture feeds containing soybean meal. In one embodiment, an aquaculture feed mixture is provided and includes a powder mixture of soybean meal and earthworm meal. The Soybean meal is provided because of its lower costs than the costs of conventional fish meals. In still another embodiment, fermented aquaculture feed mixtures are provided because fermentation of soybean meal are used to improve the absorption and utilization of nutrients within soybean meal by aquaculture animals, thereby increasing the level of soybean that can be used to substitute fish meal in aquaculture feeds.

In one aspect, the invention provides an aquaculture feed having a fermented feed mixture made by the method provided herein. The aquaculture feed may include a fermented feed mixture at a concentration of between about 60% and about 100% by weight of the total weight of the aquaculture feed, in another aspect, the invention provides a method that uses Bacillus subtilis to ferment an aquaculture feed mixture prepared from a mixture of a soybean meal and an earthworm meal. The resulting fermented mixture can be used to feed animals, shrimps and aquaculture animals. An aquaculture feed mixture of a soybean meal and an earthworm meal is provided to be fermented and improve the nutritional value of the final fermented product mixture.

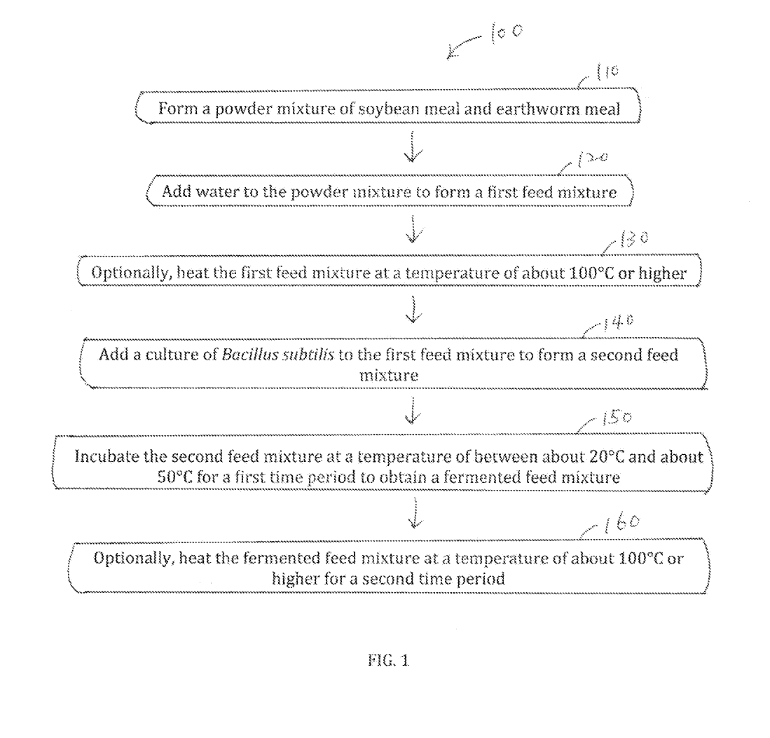

FIG. 1 provides a block diagram for a method 100 of producing an aquaculture feed mixture. At step 110, a powder mixture of soybean meal and earthworm meal is formed. In one example, the weight of the soybean meal within the power mixture is larger than the weight of the earthworm meal. Exemplary weight ratios of the soybean meal versus the earth meal may be, more than 100%, such as 120%, 150%, 200%, 300%, 400%, etc. For example, the soybean meal used in a powder mixture of 500 grams, can be 400 grams and the earthworm meal can be 100 grams, such that the weight ratios is 400%. As another example, the soybean meal used in a powder mixture of 1000 grams, can be 600 grams and the earthworm meal can be 400 grams, such that the weight ratios is 150%. In addition, the powder mixture may contain additional feed powders, such as fish meal powder, among others. In one aspect, the weight of the soybean meal within the power mixture is larger than the weight of the earthworm meal.

One example of soybean meal is powder made from seeds of legume plants. Such soybean meals contain high quantities of crude proteins which can be digested, fermented, and break down to various essential amino acids and non-essential amino acids, which include, but are not limited to, arginine, lysine, and leucine, etc., generally required for the growth of aquaculture species. In such a pre-preparation procedure (S1) described herein to prepare the powder mixture, soybean meal is used to provide high level of protein content and earthworm meal is used to increase final methionine content. Exemplary earthworm meals include powder made from the earthworm Esienia foetida.

Soybean meals used herein primarily includes non-starch polysaccharides, oligosaccharides, saponins, and phytic acid nutrition inhibiting factors, which may cause poor nutrition digestion rate in aquaculture species and an imbalance of amino acids, such as methionine. Thus, this invention uses B. subtilis fermentation to produce multiple extracellular enzymes (such as lipase, amylase, protease, nattokinase, or phytase) to convert these nutrition inhibiting factors into nutrients and bacterial proteins that can be utilized by aquaculture organisms, thereby, eliminating these nutrition inhibiting factors. This process increases nutritional content in aquaculture feeds and the economic value of soybean meal, and reduces the cost of aquaculture feeds thus prepared.

At step 120, water is added to the powder mixture to form a first feed mixture. In one example, a weight ratio of water versus the powder mixture within the first feed mixture is between about 20% and shout 50%. Our experimental results shows that at such range of weight ratio, fermentation of the first feed mixture by bacteria at later step is most desirable. In one example, the weight ratio of water versus the powder mixture within the first feed mixture is optimized at about 30%. For example, for a powder mixture of 500 grams, about 30% weight ratio, which is about 150 grams of water can be added to form into about 550 grams of a first feed mixture. In another example, about 50% of water (250 grams) versus a powder mixture of 500 grams can be mixed to form into about 750 grams of a first feed mixture.

At step 130, optionally, the first feed mixture is heated at a temperature of about 100° C. or higher to sterilize the first feed mixture and prevent any other undesirable contaminations. Any suitable sterilization process can be used to prepare the first feed mixture prior to fermentation by bacteria. For example, the first feed mixture with added water can be sterilized with high temperature steam under vacuum to eliminate unwanted bacteria.

At step 140, a culture of Bacillus subtilis is added to the first feed mixture to form a second feed mixture. In such a pre-processing procedure (S2), it is contemplated to use bacteria, such as Bacillus subtilis or other suitable bacteria suitable for fermentation, to ferment feed mixtures and break down the content of the feed mixtures into nutrients, such as amino acids (including various essential amino acids, and non-essential amino acids), fats, lipids, etc. the culture of Bacillus subtilis.

In one example, Bacillus subtilis E20 strain is used to ferment a feed mixture containing soybean meal in preparing an aquaculture feed and substituting a portion of a fish meal within the aquaculture feed mixture being fed to aquaculture animals. It is contemplated that fermented soybean meal cannot completely substitute fish meal in an aquaculture feed mixture. The reason is that soybean meal lacks methionine, an essential amino acid for aquaculture animals. Thus, earthworm meal is used to solve the problem of the lack of methionine in soybean meal.

In one example, a second feed mixture is obtained by adding a culture of Bacillus subtilis, such as about 50 mls of Bacillus subtilis culture at a concentration of 1×10⁷ cfu/ml (cfu: colony forming unit) added to about 800 grams of a first feed mixture, wherein the first feed mixture is obtained from adding water to a powder mixture of soybean meal and earthworm meal. In one aspect, the culture of Bacillus subtilis has a concentration of between about 1×10⁶ cfu/ml and about 1×10⁸ cfu/ml to promote bacteria growth. At this concentration range, the growth and metabolism of B. subtilis in the second feed mixture is optimized and can facilitate the fermentation of soybean meal. One example of B. subtilis used in this pre-processing procedure is deposited at the ROC Food Industry Research and Development Institute (deposit number BCRC 910556).

In another aspect, a weight ratio of the weight of the culture of Bacillus subtilis versus the weight of the first feed mixture is ranged from 1:100 to 1:10, such as from 1:15 to 1:12. For example, 25 mls of Bacillus subtilis culture can be added to between about 250 grams and about 2,500 grams of a first feed mixture. As another example, 50 mls of Bacillus subtilis culture can be added to about 750 grams of a first feed mixture. In another example, 50 mls of Bacillus subtilis culture can be added to about 600 grams of a first feed mixture. In one example, each gram of the second feed mixture includes at least 1×10⁶ cfu/g of bacterial count. At such a bacteria starting concentration, bacteria growth and fermentation is effectively conducted, thereby increasing the break down of crude proteins into available nutrients that can be utilized by aquaculture animals, and effectively decreasing any anti-nutritional factors in the feed mixture.

At step 150, the second feed mixture having the bacteria culture added to the first feed mixture together is incubated at a temperature of between about 20° C. and about 50° C. for a first time period to obtain a fermented feed mixture. In one example, the first time period can from about 12 hour to about 72 hours. In another example, the fermentation temperature for incubating the second feed mixture can be at an optimal growth temperature for the bacteria used, e.g., for the optimal growth temperature Bacillus subtilis is between about 37° C. and about 40° C. In one example, fermentation of the second feed mixture by bacteria can be continued at about 40° C. for a first time period of about 24 hours.

Fermentation by B. subtilis provided additional benefits because a B. subtilis can produce many extracellular enzymes (such as lipase, amylase, protease, nattokinase, or phytase) to improve the break down of crude proteins into amino acids and improve the palatability and hemagglutinin problem in earthworm meal. At the fermentation procedure (S3), the second feed mixture is fermented to produce the fermented feed mixture. Furthermore, B. subtilis has high metabolic activity at 40° C., and at such elevated incubation temperature the fermentation efficiency of B. subtilis can be increased. As a result, higher level of soybean meal and earthworm meal are fermented into higher quantity and more balanced make-up of various types of essential amino acids and non-essential amino acids in the fermented feed mixture ingredient. The resulting fermented feed mixture has the benefit of higher nutrient absorption by aquaculture animals, improved feed efficiency, and higher animal growth. The final fermented feed mixture can be used to supplement the amount of fish meal used in aquaculture feeds and reduce overall costs of aquaculture feeds.

At step 160, optionally, the method further includes heating the fermented feed mixture at a temperature of about 100° C. or higher for a second time period to sterilize the fermented feed mixture. As an example, the second time period is ranged from about 10 minutes to about 40 minutes. As another example, the fermented feed mixture can be heated to a temperature of 121° C. for about 20 minutes or more to ensure that all the bacteria in the fermented feed mixture is dead. Such a termination procedure is conducted after fermentation of the feed mixtures by bacteria to sterilize the fermented feed ingredient mixture and kill all the bacteria in the fermented feed mixture. The termination procedure can be conducted at a sterilization temperature of above 100° C. for a time period of between about 10 minutes and about 30 minutes. In such as termination procedure (S4) after the fermentation procedure (S3), high temperature (or other methods) is used to sterilize and kill bacteria in the fermented feed mixture. The sterilization process ensures that bacteria in the fermented feed mixture are dead and that nutrients such as free amino acids are released. This improves aquaculture animal utilization of nutrients contained within the fermented feed mixture.

In yet another aspect, the method may optionally include drying the fermented feed mixture to a water content of about 10% or less by weight and make it ready to be used as a portion of an aquaculture feed. For example, an oven is used to dry the fermented feed mixture at 60° C. until the water content less than 10% by weight.

The result is an aquaculture feed that conforms to the characteristics of fermented soybean meal and earthworm meal mixture ingredient. This fermented mixture ingredient can account for 60% or more, such as between 60% and 100% of total aquaculture feed weight feeding to aquaculture animals. An exemplary final aquaculture feed may contain between about 60% and about 100% by weight of the fermented feed mixture, about 20% or less by weight of fish meal, between about 10% and about 20% by weight of starch, between 0.1% and about 2% by weight of edible lipid, between about 1% and about 3% by weight of vitamins, and between about 1% and about 3% by weight of trace elements. Lipids in the feed may contain fish oil, soybean oil, and combinations thereof.

Accordingly, the method provided herein resulted in fermented feed mixtures made from soybean meal and earthworm meal to effectively increase the crude protein and free amino acid content therein, thereby increasing its substitution level for fish meal. First of all, the fermented feed mixtures thus prepared is lower in cost than conventional fish meal feed and can be used to substitute fish meal within an aquaculture feed. Second, the fermented feed mixtures thus prepared has an increased level of methionine content as compared to fermented feed mixture made from only soybean meal, thereby improving feed efficiency, and can be used to substitute fish meal with a substitution rate of up to 100%. Lastly, the fermented feed mixtures thus prepared has a general higher level of protein content, very rich in various types of free amino acids, which is beneficial to be used as aquaculture feeds.

The fermented feed mixture made from the ingredients of soybean meal and earthworm meal using the method provided herein can be used as a protein source for aquaculture feed and provide aquaculture animals with much more balance amino acids for growth. This fermented feed mixture can also improve utilization efficiency of nutrients in the feed and reduce the cost of aquaculture feed. The water content in the fermented feed mixture after the fermentation procedure S3 or the termination procedure S4 can be reduced to less than 10%.

Aquaculture teed can then be made of the final fermented feed mixture to produce appropriate nutrients based on the nutritional requirement of aquaculture species. For example, the fermented feed mixture produced by the method herein can be mixed with fiber, starch, edible oil, vitamins, and trace element in a ratio shown in Table 1 or the ratio can be adjusted to produce aquaculture feeds with different components based on the types of aquaculture animal species to be cultures in fisheries and ponds.

TABLE 1
Exemplary content of aquaculture feeds

| Composition | Weight percentage |
|---|---|
| Fermented feed mixture | 60~100% |
| Fish meal | 0~20% |
| Starch | 10~20% |
| Edible oil | 0.1~2% |
| Vitamins | 1~3% |
| Trace elements | 1~3% |

### Experiment Example

The following experiment was conducted to prove that the fermented feed mixture made from a mixture composed of soybean meal and earthworm meal using the method in this invention can actually increase usable nutrients in the final fermented mixture. By the fermented feed mixture made by controlling the amount of water added to the feed mixture prior to fermentation and optimizing fermentation conditions, the final fermented feed mixture can be used in aquaculture feeds to effectively improve feed efficiency.

(A) Effect of the Amount of Water Added to the Powder Mixture Prior to Bacteria Fermentation on the Fermented Feed Mixtures Obtained after Fermentation

In this example (A), a powder mixture containing low fat or nonfat soybean meal and earthworm meal was prepared according to the step 110 of the method 100 to a final weight of, for example, about 500 grams, and mixed in a 2-liter glass beaker. The amount (weights) of the soybean meal contained in a powder mixture is contemplated to be larger than the amount earthworm meal. For example, 400 grams of soybean meals can be mixed with 100 grams of earthworm meal. In another example, 300 grams of soybean meals can be mixed with 200 grams of earthworm meal. In still another example, 260 grams of soybean meals can be mixed with 240 grams of earthworm meal. In another example, 800 grams of soybean meals can be mixed with 200 grams of earthworm meal.

According to the step 120 of the method 100, various concentrations of first feed mixtures are then prepared. For example, weight ratios of 20%, 30%, 40%, and 50% by weight of the ingredients of water versus the powder mixture can be prepared for comparison. Distilled water was added to the beakers based on desired weight ratios and concentrations. This step was conducted in triplicates for each weight % group.

After mixing with a spatula, tin foil was used to completely cover the glass beaker and the various first feed mixtures were sterilized at, for example, a high temperature of 121° C., according to the step 130 of the method 100. After 20 minutes of sterilization the mixtures were cooled to room temperature. After cooling, sterilized first feed mixtures were moved to a sterile operating platform for inoculation.

According to the step 140 of the method 100, bacteria inoculation was conducted. For example, about 50 ml of B. subtilis E20 (bacterial count of 10⁷ cfu/ml) was inoculated into the first feed mixture and a sterile spatula was used for mixing them together to generate second feed mixtures. According to the step 150 of the method 100, the second feed mixtures were placed, for example, in a 40° C. constant temperature cultivation oven, undergoing a fermentation process. During the fermentation process, the second feed mixtures were stirred twice a day until fermented feed mixtures were obtained.

Partially and completely fermented feed mixtures were obtained, for example, by taking out about 10 grams of samples after 0, 12 hours, 24 hours, 48 hours, and 72 hours of fermentation. Bacteria counts (B. subtilis E20), crude protein content and crude lipid content within these partially and/or completely fermented feed mixtures are analyzed. A sterile spatula was used to stir the fermenting material prior to taking samples. Sterile saline solution was used to dilute the sample by ten multiples for the bacterial count analysis. Next, 100 μl of the diluted sample was placed on nutrient agar (NA). A sterile L shape glass rod was used to spread the sample, which was placed in an incubator at 40° C. for 24 hours. The external appearance of B. subtilis E20 was visually inspected and the numbers counted. Crude protein and crude lipid analysis was based on Association of Official Agricultural Chemists (A.O.A.C.) methods.

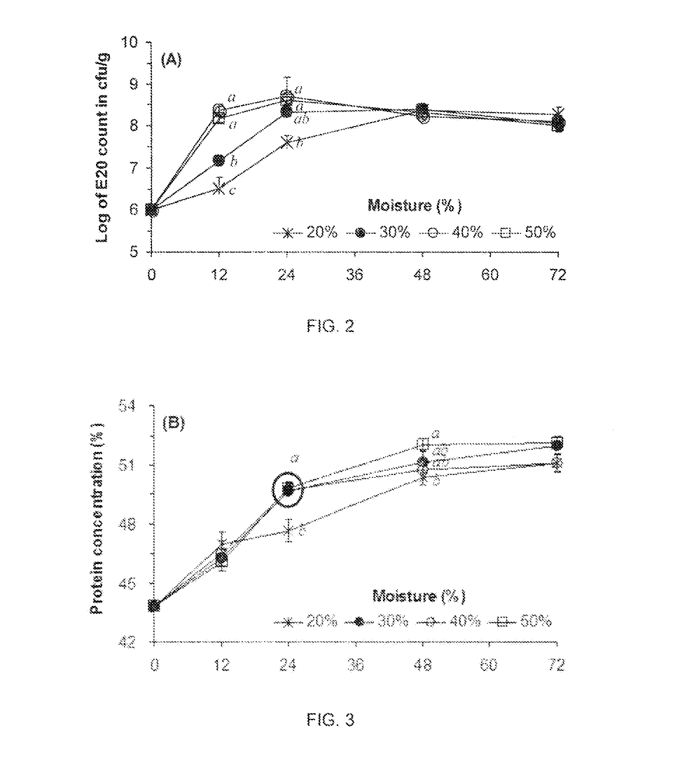

FIG. 2 is a line graph that shows the results of the effects of various amount of water added to the powder mixtures prior to fermentation on B. subtilis E20 proliferation after fermentation. Water were added to the powder mixture in weight ratios of 20%, 30%, 40% and 50% (water versus powder mixture). After 12 hours of fermentation, fermented feed mixtures made from 40% and 50% by weight of water versus powder mixture containing soybean meal and earthworm meal showed rapid increase in B. subtilis E20 bacterial count, after which time, the growth stabilized. In the treatments of fermented feed mixtures made from 20% and 30% by weight of water versus powder mixture, B. subtilis E20 bacterial growth was slower as compared to that of fermented feed mixtures made from 40% and 50% by weight of water versus powder mixture, respectively, but there is no significant difference among them after 48 hours of fermentation.

FIG. 3 is a line graph showing the effects of various amounts of water added to the powder mixture (20%, 30%, 40%, and 50% by weight of water versus powder mixture) prior to fermentation on crude protein content within the fermented feed mixtures during fermentation. After 24 hours of fermentation, fermented feed mixtures made from 30%, 40%, and 50% by weight of water versus powder mixture had crude protein contents of about 49.6±0.2%, about 49.7±0.3%, and about 49.8±0.4%, respectively (as compared to original feed mixtures without fermentation (time zero) all had about 43.8% crude protein content). After 48 hours of fermentation, crude protein content reached approximately about 51.1±0.5%, about 50.7±0.4%, and about 52.0±0.3%, respectively. However, fermented feed mixtures made from 20% by weight of water versus powder mixture had significantly lower crude protein content, as compared with other fermented feed mixtures after 72 hours of fermentation.

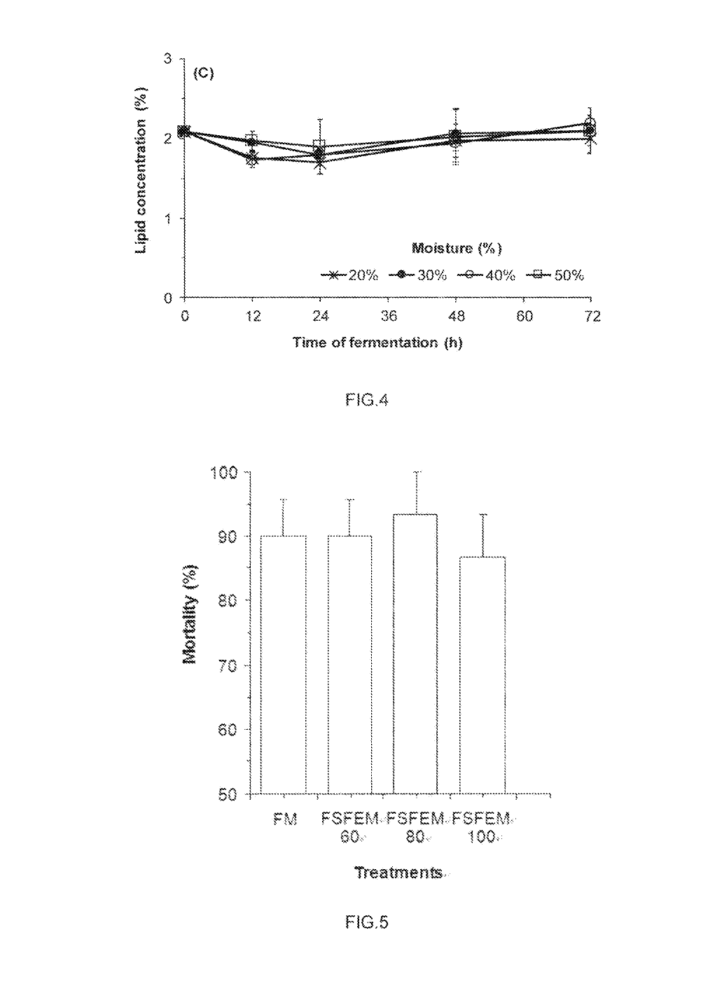

FIG. 4 is a line graph showing the effects of various amounts of water added to the powder mixture (20%, 30%, 40%, and 50% by weight of water versus powder mixture) prior to fermentation on crude lipid content within the fermented feed mixtures during fermentation. The amounts of added water did not affect the levels of crude lipid content within the fermented feed mixtures at various incubation time periods after fermentation.

In conclusion, the experimental results in (A) compare the amount of water added to the powder mixture prior to bacteria fermentation on the fermented feed mixtures obtained after fermentation and demonstrate that the amount of water added to the powder mixture can be at a weight ratios of between 20% and 50% by weight of water versus powder mixture. In addition, the time period for bacteria fermentation is optimized to be between about 12 hours and about 72 hours in a fermentation procedure S3.

(B) Comparison of Nutrient Compositions of Fishmeal (FM), Soybean Meal (SBM), Fermented Soybean Meal (FSBM), Earthworm Meal (EM), and Fermented Soybean Fermented Earthworm Meal Mixture (FSFEM) Used as Aquaculture Feeds.

In the exemplary experiments (B), fermented soybean fermented earthworm meal mixture (FSFEM) are obtained from a powder mixture of soybean meal and earthworm meal mixt added with 30% by weight of water and fermented for about 48 hours, and then sterilized at 121° C. for 20 minutes. After sterilization, a 60° C. oven was used to decrease the water content to less than 10%. The dehydrated fermented soybean fermented earthworm meal mixture (FSFEM) was crashed and analyzed for proximate nutrient composition and hydrolyzed amino acids.

Table 2 shows the results of the exemplary experiments (B). In general, conventional fish meal (FM) contains about 67.8% of crude protein and about 7.3% of crude lipid. The compositions of hydrolyzed amino acids in fishmeal (FM) contain the highest amounts of hydrolyzed amino acids among all raw meal materials. Fishmeal (FM) contains about 33.9% of essential amino acids, about 34.22% of non-essential amino acids, and as high level as about 2.4% of methionine.

Soybean meal (SBM) has a crude protein content of about 39.5%. After B. subtilis E20 fermentation, fermented soybean meal (FSBM) has a crude protein content of about 45.85%, showing about 6.35% increase in crude protein content and 8.4% increase in hydrolyzed amino acids content. However, the lipid, ash, and moisture contents did not show significant changes. The methionine content in soybean meal (SBM) is very low, at about 0.59%.

TABLE 2

| | FM | SBM | FSBM | EM | FSFEM |
|---|---|---|---|---|---|
| Composition (% dried matter) | | | | | |
| Crude protein | 67.78 ± 0.12 | 39.49 ± 0.41 | 45.85 ± 0.07 | 60.65 ± 0.07 | 49.8 ± 0.57 |
| Crude lipid | 7.25 ± 0.61 | 1.79 ± 0.1 | 2.11 ± 0.59 | 4.88 ± 0.39 | 2.46 ± 0.02 |
| Ash | 18.27 ± 0.23 | 6.35 ± 0.07 | 6.4 ± 0.01 | 9.4 ± 0.28 | 6.8 ± 0.28 |
| Moisture | 8.95 ± 0.07 | 8.01 ± 0.28 | 5.85 ± 0.51 | 6.07 ± 0.12 | 4.59 ± 0.13 |
| Hydrolyzed amino acids (%) | | | | | |
| Essential amino acids | | | | | |
| Arginine | 4.85 ± 0.1 | 3.03 ± 0.07 | 2.73 ± 0.26 | 3.12 ± 0.14 | 3.05 ± 0.06 |
| Histidine | 1.57 ± 0.04 | 1.02 ± 0.02 | 1.14 ± 0.11 | 1.79 ± 0.25 | 1.23 ± 0.02 |
| Isoleucine | 4.08 ± 0.07 | 1.9 ± 0.04 | 2.35 ± 0.16 | 1.34 ± 0.09 | 2.69 ± 0.08 |
| Leucine | 5.66 ± 0.09 | 2.97 ± 0.05 | 3.44 ± 0.23 | 3.38 ± 0.15 | 4 ± 0.11 |
| Lysine | 5.91 ± 0.07 | 2.51 ± 0.04 | 2.57 ± 0.22 | 3.27 ± 0.12 | 3.04 ± 0 11 |
| Methionine | 2.4 ± 0.02 | 0.59 ± 0.05 | 0.65 ± 0.05 | 1.02 ± 0.08 | 0.85 ± 0.03 |
| Phenylalanine | 3.28 ± 0.1 | 1.97 ± 0.05 | 2.19 ± 0.15 | 1.8 ± 0.09 | 2.33 ± 0.06 |
| Threonine | 2.98 ± 0.09 | 1.53 ± 0.03 | 1.46 ± 0.17 | 2.35 ± 0.16 | 1.7 ± 0.03 |
| Valine | 3.17 ± 0.04 | 1.66 ± 0.93 | 2.34 ± 0.13 | 1.47 ± 0.11 | 2.72 ± 0.09 |
| Non-essential amino acids | | | | | |
| Alanine | 5.12 ± 0.37 | 1.74 ± 0.03 | 1.79 ± 0.02 | 3.78 ± 0.28 | 2.2 ± 0.03 |
| Aspartate | 7.12 ± 0.13 | 4.55 ± 0.08 | 5.17 ± 0.32 | 5.64 ± 0.29 | 5.66 ± 0.16 |
| Cystine | 1.30 ± 0.86 | 2.33 ± 0.69 | 1.54 ± 0.66 | 1.38 ± 0.38 | 1.55 ± 0.3 |
| Glutamate | 10.48 ± 0.16 | 6.99 ± 0.12 | 8.36 ± 0.56 | 6.56 ± 0.29 | 8.47 ± 0.22 |
| Glycine | 4.96 ± 0.07 | 1.64 ± 0.08 | 1.98 ± 0.13 | 3.44 ± 0.2 | 2.41 ± 0.09 |
| Serine | 2.63 ± 0.09 | 1.91 ± 0.05 | 1.57 ± 0.06 | 4.69 ± 0.81 | 2.44 ± 0.09 |
| Tyrosine | 2.61 ± 0.03 | 1.47 ± 0.02 | 1.72 ± 0.09 | 1.76 ± 0.09 | 1.94 ± 0.05 |

Earthworm meal (EM) contains about 60.7% of crude protein and about 4.9% of crude lipid, and is thus a high protein content feed. However, the protein content of earthworm meal (EM) is less than that of fish meal (FM). Earthworm meal (EM) has a composition most similar to fish meal (FM). Earthworm meal (EM) has a methionine content of about 1.02%, which is less than the methionine content of 2.4% in fishmeal (FM), but is much higher than the methionine content of about 0.59% in soybean meal (SBM).

The fermented soybean fermented earthworm meal feed mixture (FSFEM) contains about 49.8% of crude protein, about 2.5% of crude lipid, about 6.8% of ash, and about 4.6% of water moisture. Most importantly, the fermented soybean fermented earthworm meal mixture (FSFEM) contains about 0.85% of methionine.

Table 3 show the results of aquaculture feed mixtures containing 60%, 80% and 100% of fermented soybean fermented earthworm meal mixtures (FSFEM), to supplement their fish meal contents, thus having 40%, 20% and 0% of fish meal (FM), respectively. Methionine levels in the aquaculture feed diets with 60%, 80% and 100% replacement of FM by FSFEM was at a range of between about 0.71% and about 0.89% (as shown in Table 3), which satisfies the recommended 0.66% required methionine content for white shrimp. The results demonstrate that methionine content in the fermented feed mixture prepared by methods of this invention can satisfy methionine requirements of white shrimp.

TABLE 3

| Proximate | | | | |
|---|---|---|---|---|
| composition | Experimental feed | | | |
| (% of dried matter) | FM | FSFEM60 | FSFEM80 | FSFEM100 |
| Moisture | 3.75 ± 0.11 | 3.21 ± 0.91 | 3.91 ± 0.04 | 3.94 ± 0.02 |
| Crude protein | 36.9 ± 0.01 | 37.6 ± 0.17 | 37.2 ± 0.01 | 36.7 ± 0.01 |
| Crude lipid | 6.6 ± 0.01 | 6.8 ± 0.12 | 7.15 ± 0.03 | 7.05 ± 0.09 |
| Ash | 13.4 ± 0.06 | 11 ± 0.01 | 10.35 ± 0.03 | 9.1 ± 0.06 |
| Methionine | 1.08 ± 0.09 | 0.89 ± 0.03 | 0.81 ± 0.03 | 0.71 ± 0.02 |

(C) Comparison of Shrimp Growth Using Aquaculture Feeds Containing Fermented Soybean Fermented Earthworm Meal Mixture (FSFEM), i.e., Fermented Feed Mixtures Made from Fermentation of Mixture of Soybean Meal and Earthworm Meal

In the exemplary experiments (C), white shrimps were fed with aquaculture feed that contain different amounts of fermented feed mixture. In these experiments, FM represents 100% fish meal feed, FSFEM60 represent 40% fish meal plus a supplement of 60% of FSFEM, FSFEM80 represent 20%% fish meal plus a supplement of 80% of FSFEM, and FSFEM100 group represent 100% of FSFEM with 0% of fish meal.

White shrimp late larvae were purchased from a private shrimp hatchery at Pingtung County, Taiwan, and stored in saltwater (salinity 35‰) tanks at the Department of Aquaculture, National Pingtung University of Science and Technology. The cement pond (6×2×1.2 m) holds 10 tons of water. Initially, shrimp were fed brine shrimp three times a day. After one week, commercial shrimp feeds were used to feed the shrimps twice a day. When the shrimp reach approximately 3 cm, saltwater was diluted to 25‰ with freshwater.

TABLE 4

| Parameters | FM | FSFEM60 | FSFEM80 | FSFEM100 |
|---|---|---|---|---|
| Water temperature (° C.) | 26.6 ± 0.1 | 26.7 ± 0.1 | 26.5 ± 0.1 | 26.4 ± 0.1 |
| Dissolved oxygen (mg/L) | 6.1 ± 0.01 | 6.3 ± 0.05 | 6.2 ± 0.01 | 6.1 ± 0.01 |
| pH | 8.1 ± 0.01 | 8.2 ± 0.01 | 8.2 ± 0.01 | 8.4 ± 0.01 |
| Total ammonia-N (mg/L) | 0.02 ± 0.01 | 0.01 ± 0.01 | 0.03 ± 0.01 | 0.03 ± 0.03 |
| Nitrite-N (mg/L) | 0.16 ± 0.05 | 0.09 ± 0.02 | 0.13 ± 0.03 | 0.21 ± 0.17 |

As shown in Table 4, water parameters for each group during the growth experiment period was maintained within the acceptable range. Water temperature was at a range of 26.3 and 26.9° C., pH was between 8.1 and 8.4, total ammonia-nitrogen was between 0.01 and 0.03 mg L⁻¹, nitrite-nitrogen was between 0.06 and 021 mg L⁻¹, and dissolved oxygen was between 6.1 and 6.3 mg L⁻¹ during the trial of growth performance (no significant difference of water parameters was recorded among groups).

The growth experiment was conducted for a total of 84 days. Experiment cement ponds have a two-ton capacity and contain 1.2 ton of 25‰ seawater. Each group had aeration and heating equipment to maintain dissolved oxygen at ≧6 mg L⁻¹ and water temperature between 26 and 27° C. Individual filters were used to remove debris from the water. Overall, 630 white shrimp (with initial mean weight of 0.22 g±0.01) were randomly placed in seven groups with triplicate. Each replicate was conducted with 30 shrimp. During the experiment period white shrimp were fed at 10% of their body weight (once at 8 am and once at 4 pm) every day. Leftover feed was removed after one hour of feeding and dried in an oven at 80° C. The amount of all diets fed was calculated by subtracting the uneaten portions, and recorded daily. Dissolved oxygen, water temperature, and pH were monitored daily during the experiment period. Shrimp weight, and ammonia-nitrogen and nitrite-nitrogen concentration in the water were tested every two weeks until the end of experiment. Shrimp were harvested and weighed individually after 84 days of culture.

Biological parameters were quantified including survival rate, weight gain, feed efficiency, special growth ratio, and daily feed intake. Survival rate (%)=(final number of shrimp/initial number of shrimp)×100%. Weight gain (%)=((final weight−initial weight)/initial weight)×100%. Feed efficiency=weight gain/total feed intake. Special growth ratio=(final weight−initial weight)/rearing day×100%. Daily feed intake (g/shrimp/day)=(total feed intake/number of shrimp)/rearing days.

Table 5 shows the results of the average body weight of white shrimps fed with different experimental feeds (FM, FSFEM60, FSFEM80, and FSFEM100 feeds). Shrimp in the FSFEM and FM groups did not show a significant difference in growth performance at 14 day of rearing. However, after 28 days of experiment, growth of shrimp fed with FSFEM100 showed a significantly lower growth rate compared with that of shrimp in the FM, FSFEM60 group and FSFEM80. At the end of the experiment, growth performance of shrimp in the FM, FSFEM60, and FSFEM80 did not show any significant difference. The final weight of shrimp were 3.8±0.24 g, 4.21±0.23 g, and 3.54±0.1 g, respectively, in the FM, FSFEM60 and FSFEM80, respectively. The average weights of shrimp in the FM, FSFEM60 and FSFEM80 were significantly higher than that of shrimp fed with FSFEM100 (1.88±0.03 g).

TABLE 5

| Experimental | Time (days) | | | | | | |
|---|---|---|---|---|---|---|---|
| Diets | 0 | 14 | 28 | 42 | 56 | 70 | 84 |
| FM | 0.22 ± 0.01 | 0.45 ± 0.02^{ab} | 0.65 ± 0.01^{cb} | 0.87 ± 0.04^{c} | 1.5 ± 0.07^{b} | 2.42 ± 0.14^{b} | 3.8 ± 0.24^{ab} |
| FSFEM60 | 0.22 ± 0.01 | 0.48 ± 0.03^{a} | 0.7 ± 0.01^{ab} | 1.04 ± 0.02^{ab} | 1.73 ± 0.03^{a} | 2.83 ± 0.13^{a} | 4.21 ± 0.23^{a} |
| FSFEM80 | 0.22 ± 0.01 | 0.49 ± 0.01^{a} | 0.76 ± 0.04^{a} | 1.16 ± 0.02^{a} | 1.78 ± 0.06^{a} | 2.52 ± 0.14^{ab} | 3.54 ± 0.1^{b} |
| FSFEM100 | 0.22 ± 0.01 | 0.41 ± 0.02^{bc} | 0.58 ± 0.03^{c} | 0.85 ± 0.03^{c} | 1.15 ± 0.06^{c} | 1.54 ± 0.04^{c} | 1.88 ± 0.03^{c} |

TABLE 6

| Parameters | FM | FSFEM60 | FSFEM80 | FSFEM100 |
|---|---|---|---|---|
| Survival rate (%) | 96.67 ± 3.33^{a} | 90.03 ± 3.33^{a} | 88.87 ± 4.43^{a} | 92.2 ± 1.10^{a} |
| Weight gain (%) | 1627.6 ± 59.91^{ab} | 1814.57 ± 103.14^{a} | 1509.43 ± 46.12^{b} | 756.5 ± 11.89^{c} |
| Special growth | 4.26 ± 0.28^{ab} | 4.75 ± 0.27^{a} | 3.95 ± 0.12^{b} | 1.98 ± 0.03^{c} |
| ratio | | | | |
| Daily feed intake | 0.09 ± 0.009^{a} | 0.09 ± 0.003^{a} | 0.08 ± 0.003^{a} | 0.05 ± 0.003^{b} |
| (g/shrimp/day) | | | | |
| Feed efficiency | 0.47 ± 0.01^{a} | 0.53 ± 0.04^{a} | 0.5 ± 0.01^{a} | 0.46 ± 0.01^{a} |

Table 6 shows no significant difference in survival of white shrimp in different feed groups after 84 days of feeding. The FSFEM60, FSFEM80, and FM groups did not show a significant difference in weight gain, special growth ratio, daily feed intake, and feed intake. However, shrimp that feeds only on FSFEM had lower weight gain, special growth ratio and feed intake than shrimp that fed on FM, FSFEM60, and FSFEM80. Shrimp in different feed groups showed no difference in feed efficiency. Methionine content in different feeds (FSFEM60, FSFEM80, and FSFEM100) used in these experiments satisfied the minimum amount of methionine requirement of white shrimp, which explains why there was no significant difference in the feed efficiency among test groups.

(D) Component Analysis of Shrimp Meat

In experiment example (D), shrimp meat from white shrimp fed with different feeds (different fermented mixture ingredient substitution proportion) were analyzed. In this experiment, FM represents all fish meal feeds, FSFEM60 represents 60% substitution of fish meal with FSFEM, FSFEM80 represents 80% substitution of fish meal with FSFEM, and FSFEM100 represents 100% substitution of fish meal with FSFEM. After the growth experiment ended, shrimp were not fed for one day. White shrimp were selected at random from each group and sacrificed to test the composition of the shrimp meat. White shrimp samples were first cold treated and excess water on the shrimp wiped off. The shrimp heads and shells were removed and the aforementioned component analysis conducted to analyze water, crude protein, crude lipid, and ash content in the shrimp meat.

TABLE 7

| | White shrimp meat composition (%) | | | |
|---|---|---|---|---|
| Feed | Moisture | Crude protein | Crude lipid | Ash |
| FM | 76.75 ± 0.24 | 19.75 ± 0.28 | 0.72 ± 0.07 | 1.5 ± 0.02 |
| FSFEM60 | 76.61 ± 0.23 | 19.91 ± 0.04 | 0.77 ± 0.07 | 1.44 ± 0.03 |
| FSFEM80 | 76.69 ± 0.26 | 19.46 ± 0.13 | 0.72 ± 0.05 | 1.51 ± 0.01 |
| FSFEM100 | 76.77 ± 0.15 | 19.67 ± 0.31 | 0.71 ± 0.05 | 1.44 ± 0.01 |

Table 7 shows the proximate composition of abdomen muscle of shrimp fed with different feeds (FM, FSFEM60, FSFEM80, and FSFEM100) for 84 days. No significant differences in the proximate composition of abdomen muscle of shrimp were recorded among FM and other groups. The moistures of muscle was between 76.6% and 76.9%, crude protein content was between 19.1% and 19.9%, crude lipid content was between 0.71% and 0.8%, and ash content was between 1.4% and 1.5%. The results indicate that white shrimp muscle composition was not affected by different FSFEM proportions in the feed mixtures.

(E) Pathogen Challenge Experiments

After the growth experiments, we also conducted pathogen challenge experiments to determine whether different experimental feed (FSFEM60, FSFEM80, and FSFEM100) had an effect on shrimp health. In addition, sterile saline solution was used on shrimps in the control group. Vibrio alginolyticus, a pathogen of white shrimp was used in this experiment. V. alginolyticus strain was obtained from infected white shrimp, and stored at −70° C. in 20% glycerin. Prior to use, V. alginolyticus was cultivated for 24 hours in tryptic soy broth (TSB) liquid culture that contained 1.5% NaCl at 28° C. and 100 rpm. After 24 hours, bacteria were collected by centrifugation at 8000×g and 4° C. for 20 minutes. Sterilized saline solution (0.85%) was used to dilute pathogen to a concentration appropriate for pathogen challenge experiment. Ten microliters of the solution was injected into the sinus of the shrimp, resulting in a 10⁶ cfu/g shrimp. After injections, shrimp were placed back into their original aquarium for seven days to observe their mortality. Additionally, a control group of shrimp were injected with 0.85% sterilized saline solution.

As shown in FIG. 5, control group shrimps injected with saline solutions had a mortality rate of 0%. White shrimp (separately fed with FM, FSFEM60, FSFEM80, and FSFEM100) injected with V. alginolyticus for 7 days had mortality rates between 86.7% and 93.3%, and no significant differences existed among groups. Soybean meal fermented with microorganisms can improve the negative effects of soybean meal on animal immunity. Thus, V. alginolyticus infection of white shrimp fed with different experimental feed did not result in significantly different mortality rates.

Experiment results showed that the method of preparing the fermented feed mixture of soybean meal and earthworm meal can improve nutrition and palatability of earthworm meal. The preparation method for fermented mixture of soybean meal and earthworm meal in this invention can effectively increase crude protein and free amino acid content in mixture ingredient, thereby, increase substitute levels for fish meal in diet, and decrease feed costs. Fermented mixture of soybean meal and earthworm meal produced by the preparation method in this invention can increase methionine content and improve feed efficiency.

Aquaculture feed that use the fermented feed mixtures of soybean meal and earthworm meal produced by this invention is a good source of proteins that not only can increase the amount on free amino acids in feed but can also decrease feed costs. This invention provides an aquaculture feed formed from fermented mixture of soybean meal and earthworm meal, including the fermentation preparation method for the mixture ingredient. When produced, the mixture ingredient can be utilized in the industry. Therefore, this invention possesses industry applicability. Although the use of this invention has been demonstrated using an example, it is not limited to this use. Any person familiar with this skill and that does not depart from the spirit and scope of this invention while changing or modifying any of the aforementioned examples still falls in the protective scope of the skill.

While the foregoing is directed to embodiments of the present invention, other and further embodiments of the invention may be devised without departing from the basic scope thereof, and the scope thereof is determined by the claims that follow.

What is claimed:

1. A method for producing an aquaculture feed mixture, comprising:
forming a powder mixture of soybean meal and earthworm meal, wherein the weight of the soybean meal within the power mixture is larger than the weight of the earthworm meal;
adding water to the powder mixture to form a first feed mixture, wherein a ratio of the weight of water versus the weight of the powder mixture is between about 20% and about 50%;
adding a culture of Bacillus subtilis to the first feed mixture to form a second feed mixture; and
incubating the second feed mixture at a temperature of between about 20° C. and about 50° C. for a first time period to obtain a fermented feed mixture.

2. The method of claim 1, wherein the ratio of the weight of water versus the weight of the powder mixture is about 30%.

3. The method of claim 1, further comprising heating the first feed mixture at a temperature of about 100° C. or higher prior to adding the culture of Bacillus subtilis.

4. The method of claim 1, wherein the first time period is from about 12 hour to about 72 hours.

5. The method of claim 1, further comprising heating the fermented feed mixture at a temperature of about 100° C. or higher for a second time period.

6. The method of claim 1, wherein the second time period is from about 10 minutes to about 40 minutes.

7. The method of claim 1, further comprising drying the fermented feed mixture to a water content of about 10% or less by weight.

8. The method of claim 1, wherein a weight ratio of the weight of the culture of Bacillus subtilis versus the weight of the first feed mixture is ranged from 1:15 to 1:12.

9. The method of claim 1, wherein the culture of Bacillus subtilis has a concentration of between about 1×10⁶ cfu/ml and about 1×10⁸ cfu/ml.

10. An aquaculture feed comprising a fermented feed mixture of claim 1.

11. The aquaculture feed of claim 10, wherein the fermented feed mixture is between about 60% and about 100% by weight of the total weight of the aquaculture feed.

12. The aquaculture feed of claim 11, further comprising:
fish meal at a concentration of between 0% and about 40% by weight.

13. The aquaculture feed of claim 10, further comprising:
starch at a concentration of between about 10% and about 20% by weight.

14. The aquaculture feed of claim 10, further comprising:
oil at a concentration of between about 0.1% and about 2% by weight.

15. The aquaculture feed of claim 14, wherein the oil in the aquaculture feed is selected from the group consisting of fish oil, soybean oil, and combinations thereof.

16. The aquaculture feed of claim 10, further comprising:
vitamins at a concentration of between about 1% and about 3% by weight.

17. The aquaculture feed of claim 10, further comprising:
trace elements at a concentration of between about 1% and about 3% by weight.

18. An aquaculture feed, comprising:
a fermented feed mixture obtained from adding a culture of Bacillus subtilis to a first feed mixture to form a second feed mixture and incubating the second feed mixture at a temperature of between about 20° C. and about 50° C. for a first time period, wherein the first mixture is obtained from adding water to a powder mixture of soybean meal and earthworm meal, wherein the weight of the soybean meal within the power mixture is larger than the weight of the earthworm meal.

19. The aquaculture feed of claim 18, wherein the fermented feed mixture is between about 60% and about 100% by weight of the total weight of the aquaculture feed.

20. The aquaculture feed of claim 18, further comprising:
fish meal at a concentration of between 0% and about 40% by weight.
